(19) United States
(12) Patent Application Publication
(10) Pub. No.: US 2004/0200988 A1
(43) Pub. Date: Oct. 14, 2004

(54) Ball valve with fused end caps

(75) Inventors: James M. Lorenz, Madison, OH (US); Jerome H. Smith, Chagrin Falls, OH (US)

Correspondence Address: Christopher B. Fagan, Fay, Sharpe, Fagan, Minnich & McKee, LLP, 7th Floor, 1100 Superior Avenue, Cleveland, OH, 44114-2518, US

(73) Assignee: Perfection Corporation

(21) Appl. No.: 10/413,232

(22) Filed: Apr. 14, 2003

(51) Int. Cl. F16K 5/06

(52) U.S. Cl. 251/315.14

(57) ABSTRACT

A ball valve assembly including a valve body having opposing ends and an inside wall extending between the opposing ends. The inside wall forms a central passage and includes capturing portions disposed along the inside wall adjacent each of the opposing ends. The assembly also includes a valve ball rotatably supported within the central passage of the valve body and a valve stem extending through the valve body into the central passage and interengaging a ball valve for transmitting rotational motion thereto. The ball valve has an inside wall that forms a fluid passage therethrough. A pair of retainers is positioned within the central passage on opposing sides of the valve ball. Each of the retainers forms a fluid-tight seal between the valve ball and the valve body. A pair of press rings, captured at least partially within the central passage, is each in abutting engagement a different one of the retainers.

This invention relates to the art of fluid valves and, more particularly, to an improved ball valve structure.

### INCORPORATION BY REFERENCE

Ball valves are generally known, and one example of a ball valve is generally shown and described in O'Connell, et al., U.S. Pat. No. 5,397,101, which is hereby incorporated herein by reference as background information.

### BACKGROUND OF THE INVENTION

The present invention finds particular application in underground natural gas distribution systems and will be described with particular reference thereto. It is to be appreciated, however, that the invention is capable of broader application and is equally applicable for use in many other environments, such as in a laboratory or industrial facility, for example, and for a wide variety of other fluids.

Ball valves have been provided heretofor and generally include a valve body having a central passage and a valve ball having a fluid passage and rotatably supported within the central passage. As with any valve, to function properly, a seal must be established between the valve body and valve ball such that fluid only flows through the ball valve assembly when the fluid passage through the valve ball is in fluid communication with the central passage of the valve body.

Earlier ball valve assemblies have been made from metal components that were dimensionally stable and relatively easy and efficient to assemble. However, due to issues such as cost and corrosion, metal valve assemblies have given way to valve assemblies constructed from plastic materials. Unfortunately, plastic valve components cannot be assembled in the same manner as metal components and still retain the desired sealing effectiveness and quality. As such, other designs have been developed for plastic ball valve assemblies that provide a reliable and efficient seal between the valve body and valve ball. One such example is shown and described in O'Connell. Unfortunately, while such designs produce high-quality ball valves, the same proven to be difficult and inefficient to assemble. This has resulted in an increase in assembly time, which, in turn, undesirably increases the cost of the valve.

### SUMMARY OF THE INVENTION

A ball valve assembly in accordance with the present invention is provided that includes a valve body having opposing ends and an inside wall extending between the opposing ends. The inside wall forms a central passage and includes a first capturing portion disposed therealong adjacent each of the opposing ends. A valve ball is rotatably supported with in the central passage of the valve body and has an inside wall that forms a fluid passage. A valve stem extends through the valve body into the central passage and interengages the valve ball in a manner suitable for transmitting rotational motion thereto. A pair of retainers is positioned with the central passage on opposing sides of the ball valve. Each of the retainers forms a fluid-tight seal between the valve ball and the valve body. A pair of press rings is captured at least partially within the central passage. Each press ring is in abutting engagement with a different one of the retainers and includes an outer wall having a second capturing portion interengaging the associated first capturing portion of the valve body.

Additionally, a polymeric ball valve assembly is provided that includes a polymeric valve body having opposing end walls, an inside wall forming a central passage extending between the opposing end walls, and an annular groove disposed along the central passage adjacent each of the opposing ends thereof. Each of the annular grooves extends radially outwardly into the valve body. A polymeric valve ball is rotatably supported with the central passage of the valve body. The polymeric valve ball has an exterior wall and an inside wall that forms a fluid passage extending through the valve ball. At least a portion of the exterior wall has a spherical surface. A valve stem extends through the valve body into the central passage and interengages the valve ball. A first and a second polymeric seal retainer are each supported within the central passage on opposing sides of the valve ball. Each of the seal retainers includes an elastomeric ball sealing member and an elastomeric body sealing member. Each of the ball sealing members are compressively positioned between the spherical surface of the valve ball and a respective one of the seal retainers forming a fluid-tight seal therebetween. Each of the body sealing members is compressively positioned between the respective sealing member and the inside wall of the valve body. A first and a second polymeric press ring is each captured within the central passage. Each of the press rings abuttingly engage a different one of the first and second seal retainers. Each of the press rings have a generally radial exterior wall and an annular ridge extending radially outwardly from the exterior wall. The annular ridge of each of the first and second press rings is received in a different one of the grooves of the valve body to capture the press rings at least partially within the central passage.

A method of assembling a ball valve assembly is provided and includes the following steps. One step includes providing the individual components of the ball valve assembly to be assembled, including a valve body, a valve ball, a valve stem, a first and a second retainer, and a first and a second press ring. The valve body having a central inside wall forming a central passage and a secondary inside wall forming a stem passage extending through the valve body into and generally transverse the central passage. Another step includes providing a base fixture and positioning the first press ring on the base fixture. Still another step includes supporting the first retainer generally coaxially on the first press ring. Further steps include assembling the valve ball into the central passage of the valve body with the valve stem extending through the stem passage of the valve body and interengaging the valve ball. Still a further step includes supporting the valve body with the valve ball and valve stem on the first retainer such that the central passage is generally coaxial with the first retainer. Yet a further step includes supporting the second retainer on the valve body opposite the first retainer such that the second retainer is positioned generally coaxially with the central passage. Another step includes supporting the second press ring generally coaxially on the second retainer. Still other steps include positioning a second fixture adjacent the second press ring and axially displacing at least one of the base fixture and the second fixture toward one another until the first and second press rings are at least partially received in opposing ends of the central passage.

### BRIEF DESCRIPTION OF THE DRAWINGS

FIG. 1 is a front elevation view of a ball valve assembly in accordance with the present invention.

FIG. 2 is a partial top plan view of the ball valve assembly shown in FIG. 1 taken from line 2-2.

FIG. 3 is a front elevation view, shown in cross-section, of the ball valve arrangement shown in FIG. 1.

FIG. 4 is an exploded front elevation view, shown in cross-section, of a portion of the ball valve assembly shown in FIG. 3.

FIG. 5 is a front plan view, shown in cross-section, of the valve body shown in FIGS. 3 and 4.

FIG. 6 is a side elevation view of the valve ball shown in FIGS. 3 and 4.

FIG. 7 is a top plan view, shown in partial cross-section, of the valve ball shown in FIGS. 3 and 4.

FIG. 8 is a side elevation view, shown in cross-section, of the inner seal retainer shown in FIGS. 3 and 4.

FIG. 9 is a side elevation view, shown in cross-section, of the outer seal retainer shown in FIGS. 3 and 4.

FIG. 10 is a side elevation view, shown in cross-section, of the press ring shown in FIGS. 3 and 4.

FIG. 11 is a side elevation view, shown in partial cross-section, of the ball valve assembly shown in FIGS. 3 and 4 in association with assembly fixtures prior to assembly.

### DETAILED DESCRIPTION OF THE INVENTION

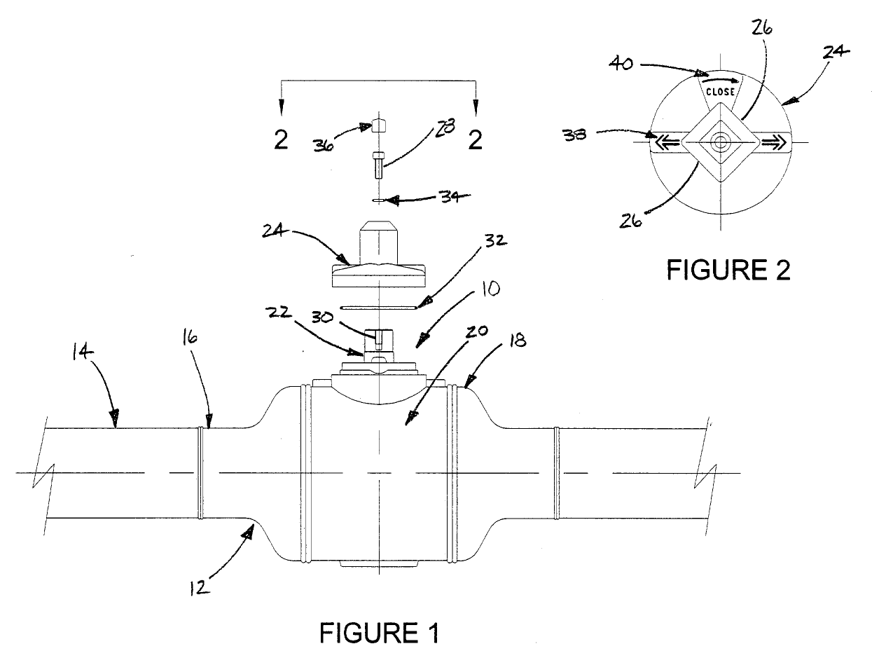

Referring now to the drawings, wherein the showings are for the purpose of illustrating preferred embodiments of the invention only and not for the purpose of limiting the same, FIG. 1 illustrates a ball valve assembly 10 shown assembled with a pair of opposing end caps 12 and transmission lines or pipes 14. The end caps each have a first end 16 connected to a pipe 14 in a suitable manner to form a fluid-tight connection therebetween. The end caps each have a second end 18 opposite first end 16 that is cooperable with a valve body 20 of ball valve assembly 10 for forming a fluid-tight connection therewith. Commonly, transmission lines or pipes 14 are formed from a polymeric material. For the purposes of this disclosure, the term polymeric material is to be interpreted very broadly and considered to include any suitable natural or synthetic organic compound. Examples of suitable polymeric materials include, but are not in any way limited to, natural and synthetic rubbers, thermosets and thermoplastics. Pipes 14 are commonly formed from an olefin-based thermoplastic, such as polyethylene or polypropylene. In which case, end caps 12 and valve body 20 are preferably formed from a material suitable for forming fluid-tight joints therebetween, such as from a similar olefin-based thermoplastic, such as polyethylene or polypropylene, for example.

Ball valve assembly 10 includes a valve stem 22 that extends from valve body 20 and is rotatable relative thereto. A valve operator 24 interengages valve stem 22 such that rotational motion applied to valve operator 24 via wrench flats 26 (FIG. 2) is transmitted to valve stem 22. Valve operator 24 is secured to valve stem 22 in any suitable manner, such as by using a fastener 28 extending through the valve operator and engaging a corresponding threaded hole 30 in valve stem 22. Sealing members, such as o-rings 32 and 34, for example, are respectively positioned between valve body 20 and valve operator 24 and between valve operator 24 and fastener 28 to minimize the ingress of external fluids and other contaminants. A plug 36 is provided on valve operator 24 adjacent fastener 28 to minimize corrosion and the collection of contaminants. As shown in FIG. 2, indicia 38 and 40 are typically provided on valve operator 24 to indicate the relative position or flow condition of the valve.

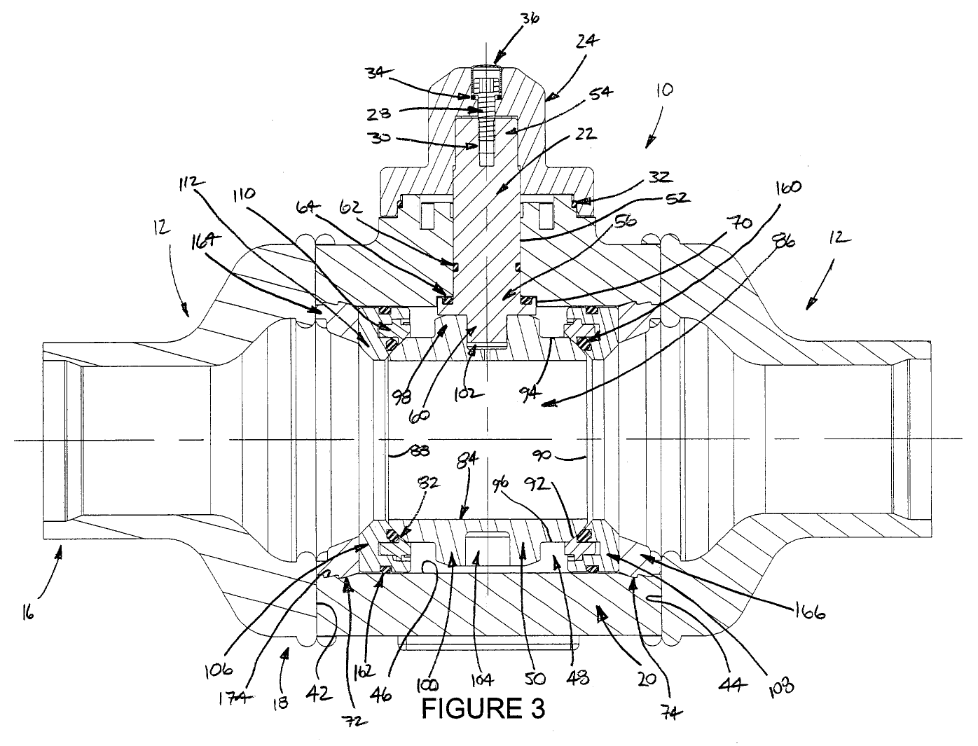

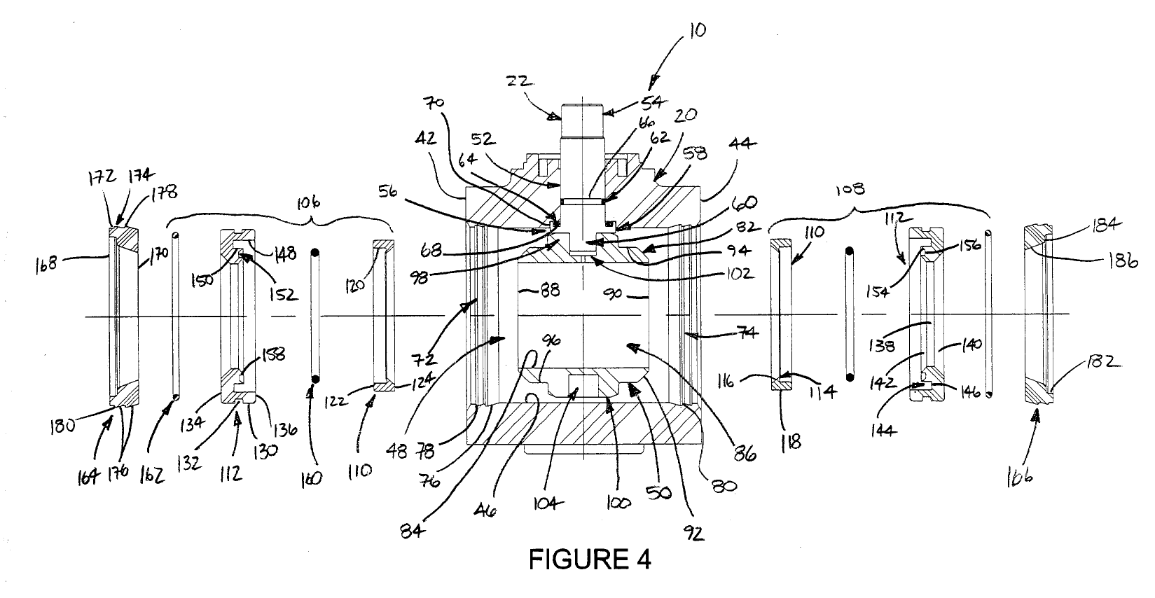

FIGS. 3 and 4 respectively illustrate cross-sectional front elevation views of ball valve assembly 10 with and without end caps 12. Each length of pipe is suitably connected to an end cap, such as by adhesive or welding, for example, and preferably by hot plate welding, to form a fluid-tight seal therebetween. Each end cap is attached to valve body 20 of ball valve 10 in a suitable manner, such as by hot plate welding, for example.

Valve body 20 has opposing end walls 42 and 44 and an inside wall 46 extending through the valve body between end walls 42 and 44. The inside wall forms a central passage 48 in which a valve ball 50 is supported. Valve stem 22 extends through a stem passage 52 in valve body 20. Valve stem 22 is generally cylindrical having a first end 54 projecting out of valve body 20 and receiving valve operator 24. The valve stem has an opposing second end 56 captured within central passage 48 of the valve body. Second end 56 includes a radially outwardly extending shoulder portion 58 and an axially extending projection 60. It will be appreciated that projection 60 is preferably of a non-cylindrical shape or configuration, such as square or rectangular, for example, or any other suitable shape for transmitting rotational motion from valve stem 22 into valve ball 50.

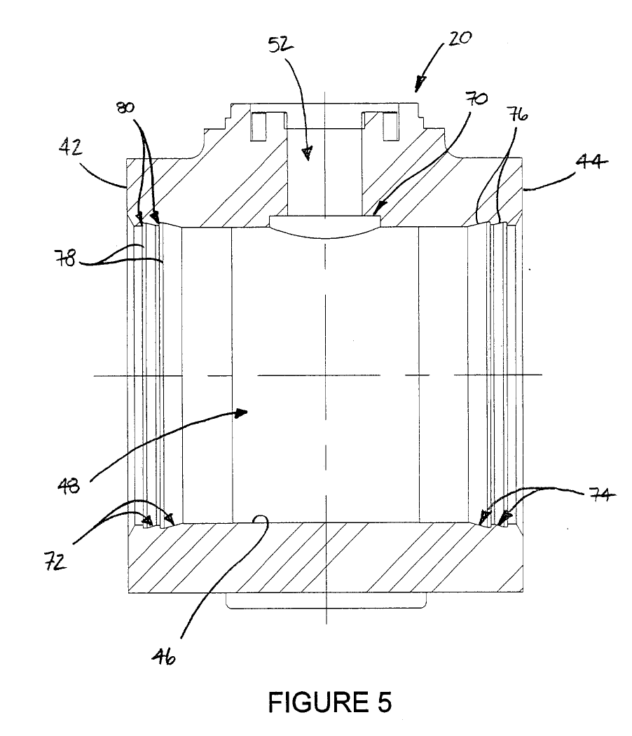

Sealing members, such as o-rings 62 and 64, for example, are respectively captured within retaining grooves 66 and 68 on valve stem 22 to minimize the ingress of external contaminants into central passage 48 and the egress of fluid from the same. As can be better seen in FIG. 5, a counterbore 70 is provided at one end of stem passage 52 for receiving shoulder portion 58 of valve stem 22. Additionally, inside wall 46 of valve body 20 includes a plurality of capturing grooves 72 and 74 respectively adjacent end walls 42 and 44 of the valve body. It will be appreciated that capturing grooves 72 and 74 are substantially identical and are given different item numbers to differentiate between their respective positions on valve body 20. Each of the capturing grooves, however, includes a frustoconical portion 76 and a cylindrical portion 78 forming a shoulder portion 80 in each of the grooves.

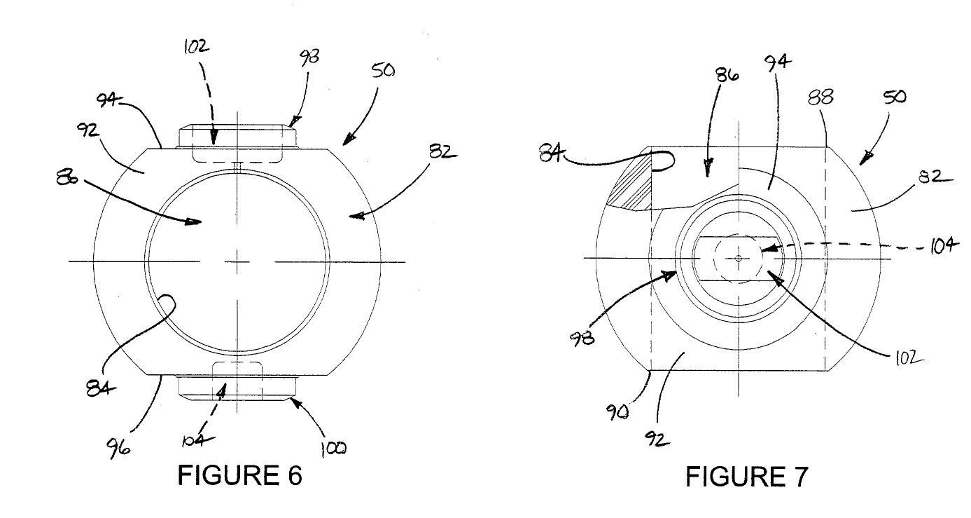

Turning now to FIGS. 3, 4, 6 and 7, valve ball 50 is supported within central passage 48 and has an exterior wall 82 and an inside wall 84 forming a fluid passage 86 through valve ball 50 between end walls 88 and 90. Exterior wall 82 has a substantially spherical portion 92 and opposing flat portions 94 and 96. Bosses 98 and 100 extend radially outwardly opposite one another from flat portions 94 and 96, respectively. Cavities 102 and 104 are respectively provided in bosses 98 and 100. It will be appreciated that cavity 102 is shown as being elongated and suitable for receiving and interengaging axial projection 60 of valve stem 22. As such, rotational motion from valve stem 22 can be transmitted through projection 60 into valve ball 50 via the interengagement of projection 60 with cavity 102.

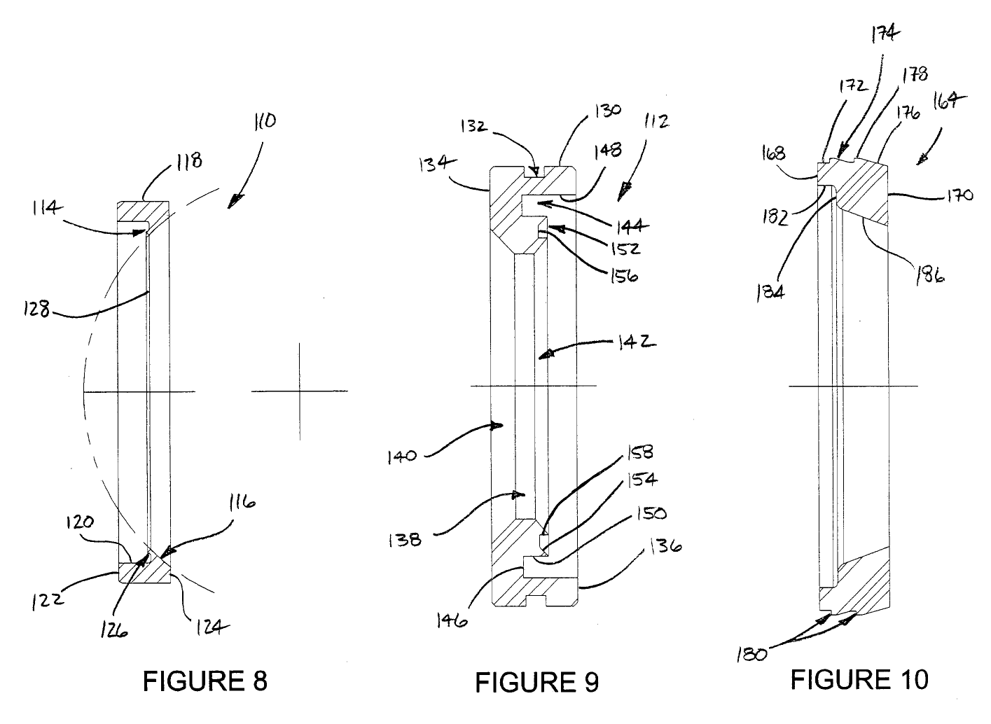

As shown in FIGS. 3, 4, 8 and 9, seal retainers 106 and 108 are positioned within central passage 48 on opposing sides of valve ball 50. It will be appreciated that seal retainers 106 and 108 are substantially identical, and are given different item numbers to differentiate between different positions relative to the valve ball. Each of the seal retainers includes an inner seal retaining ring 110 and an outer seal retaining ring 112. As can be seen in FIG. 8, inner seal ring 110 includes a radially inwardly extending lip or flange 114 and a spherical surface 116 cooperable with spherical portion 92 of exterior wall 82 of valve ball 50. Inner seal retaining ring 110 includes an external wall 118, an internal wall 120 from which flange 114 radially inwardly extends, and opposing end walls 122 and 124. Flange 114 has an axially extending hook portion 126 and a frustoconical wall portion 128 extending generally opposite spherical surface 116.

Turning now to FIG. 9, outer seal retaining ring 112 has a generally cylindrical external wall 130 with a radially inwardly extending annular groove 132. External wall 130 extends between end walls 134 and 136. Outer seal retaining ring 112 also includes a generally cylindrical internal wall 138 and opposing frustoconical walls 140 and 142 extending radially outwardly from internal wall 138. A first axially extending annular groove 144 extends from end wall 136 into outer seal retaining ring 112 and has a bottom wall 146 and annular side walls 148 and 150. A second axially extending annular groove 152 is provided adjacent first groove 144 and extends into outer seal retaining ring 112 generally in the direction of end wall 134. Second annular groove 152 includes a frustoconical wall portion 154, a bottom wall portion 156 and a side wall portion 158.

Seal retainers 106 and 108 include sealing members, such-as o-rings 160 and 162 shown in FIGS. 3 and 4, for example. It will be appreciated that external and internal walls 118 and 120 of inner seal retaining ring 110 are received within first annular groove 144 of outer seal retaining ring 112. As the inner and outer seal retaining rings are assembled together, flange 114 of inner ring 110 and second annular groove 152 of outer ring 112 form a groove suitable for retaining a sealing member, such as o-ring 160. Additionally, a sealing member, such as o-ring 162, is received in annular groove 132 in external wall 130 of outer retaining ring 112. Each seal retainer 106 and 108 is positioned within central passage 48 adjacent opposing sides of valve ball 50 such that o-ring 160 is compressively positioned between the inner and outer retaining rings and the spherical portion of exterior wall 82 of the valve ball, and o-ring 162 is compressively positioned between outer seal retaining ring 112 and inside wall 46 of valve body 20. It will be appreciated that once properly positioned within central passage 48, seal retainers 106 and 108 form a substantially fluid-tight seal between valve ball 50 and valve body 20.

Seal retainers 106 and 108 are prevented from moving substantially away from valve ball 50 by press rings 164 and 166, respectively, as shown in FIG. 3. It will be appreciated that press rings 164 and 166 are substantially identical to one another and are given different item numbers to differentiate between relative position within ball valve assembly 10. FIG. 10 refers specifically to item number 164 but is equally applicable to press ring 166. Each of the press rings is a substantially annular ring extending between spaced apart end walls 168 and 170. Each press ring includes an external wall 172 extending from end wall 168. A plurality of annular barbs 174 extend radially outwardly from exterior wall 172 and include a frustoconical wall portion 176 and a cylindrical wall portion 178 forming a shoulder portion 180. An inside wall 182 extends axially inwardly from adjacent end wall 168 to an intermediate wall 184 extending radially inwardly from inside wall 182. A frustoconical inside wall 186 extends radially inwardly toward end wall 170 from adjacent intermediate wall 184. Press rings 164 and 166 are captured within central passage 48 in abutting engagement with seal retainers 106 and 108, respectively, by barbs 174 engaging capturing grooves 72 and 74 of inside wall 46.

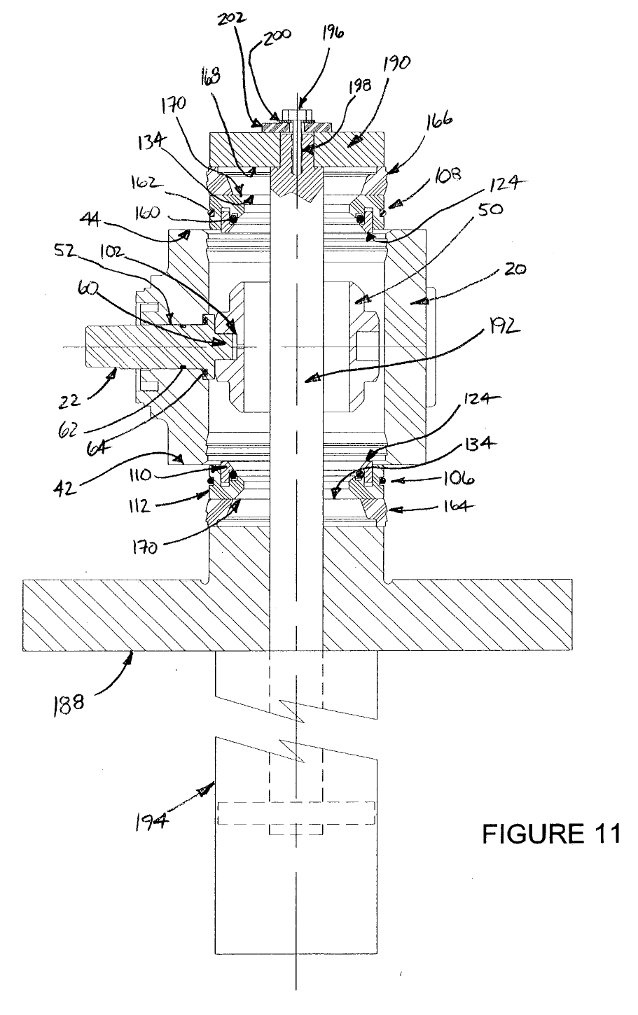

In assembling ball valve assembly 10, in accordance with the present invention, press ring 164 is positioned on a base fixture 188 with end wall 170 extending away from the fixture, as shown in FIG. 11. Seal retainer 106 or both seal retainers 106 and 108 are assembled from inner and outer seal retaining rings 110 and 112 and fitted with sealing members, such as o-rings 160 and 162. End wall 134 of outer seal retaining ring 112 is positioned in abutting engagement with end wall 170 of press ring 164 and substantially centered thereon. Sealing members, such as o-rings 62 and 64, are fitted onto valve stem 22, and axial projection 60 thereof is interengaged with cavity 102 in valve ball 50. The valve stem and valve ball are together fitted into valve body 20 such that valve stem 22 extends into and projects from stem passage 52 with o-rings 62 and 64 compressively positioned between the valve stem and valve body. Valve body 20 together with valve stem 22 and valve ball 50 are positioned such that end wall 42 is adjacent end wall 124 of inner seal retaining ring 110. Thereafter, seal retainer 108 is positioned adjacent valve body 20 such that end wall 124 of inner seal retaining ring 110 is adjacent end wall 44. Press ring 166 is positioned on seal retainer 108 such that end wall 170 of the press ring is adjacent end wall 134 of outer seal retaining ring 112. A second fixture 190 is positioned on end wall 168 of press ring 166. An actuator rod 192 of an actuator 194 extends through base fixture 188 to second fixture 190 and is removably attached thereto in any suitable manner. For example, a threaded fastener 196 engaging a threaded hole 198 in actuator rod 192. A flat washer 200 and a quick-connect plate 202 are positioned between fastener 196 and second fixture 190. Quick-connect plate 202 can include a slot (not shown) permitting removal of the quick-connect plate and second fixture without the need for removal of the fastener and flat washer from the actuator rod. Once the component parts and associated fixtures have been arranged, as shown in and discussed with regard to FIG. 11, the base fixture and second fixture are displaced toward on another forcing the component parts of the ball valve assembly toward one another. The displacement continues until the two opposing press rings are at least partially captured within the central passage of the valve body. In one embodiment, the press rings are preferably captured such that end walls 168 of press rings 164 and 166 are respectively recessed within central passage 48 relative to end walls 42 and 44, a distance of about 1/64 of an inch to about ½ of an inch, and, more preferably, about ⅛ of an inch.

As an additional step, a thin layer of any suitable grease or other lubricant can optionally be applied to each sealing member prior to assembly with other corresponding component parts. Additionally, the grease can be applied along inside wall 46 inboard of grooves 72 and 74 to facilitate assembly of the sealing members into central passage 48. Each of the component parts of the ball valve assembly is preferably formed from a polymeric material, as discussed above, such as polyethylene or polypropylene, for example. However, it is to be distinctly understood that certain components, such as valve stem 22, inner seal retaining rings 110 and outer seal retaining rings 112, for example, can be formed from other suitable materials, such as metal, for example.

While the invention has been described with reference to preferred embodiments and considerable emphasis has been placed herein on the structure and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. Rather, it is intended that the invention be construed as including all such modifications and alterations insofar as they come within the scope of the appended claims and the equivalents thereof.

What is claimed is:

1. A ball valve assembly comprising:
a valve body having opposing end walls and an inside wall extending between said opposing end walls, said inside wall forming a central passage and having a first capturing portion disposed therealong adjacent each of said opposing end walls;
a valve ball rotatably supported within said central passage of said valve body and having an inside wall that forms a fluid passage therethrough;
a valve stem extending through said valve body into said central passage and interengaging said valve ball for transmitting rotational motion thereto;
a pair of retainers positioned within said central passage on opposing sides of said valve ball, each of said retainers forming a fluid-tight seal between said valve ball and said valve body; and,
a pair of press rings captured at least partially within said central passage, each press ring in abutting engagement with a different one of said retainers and includes an outer wall having a second capturing portion interengaging said first capturing portion on said valve body.

2. A ball valve assembly according to claim 1, wherein each of said press rings has a first and a second end wall, said first end wall of each press ring is in abutting engagement with an associated one of said pair of retainers, said second end wall of each press ring is recessed into said valve body from an associated one of said opposing end walls thereof.

3. A ball valve assembly according to claim 2, wherein each of said press rings is recessed into said valve body from about 1/64 of an inch to about ½ an inch.

4. A ball valve assembly according to claim 1, wherein each of said first capturing portions of said valve body includes a radially outwardly extending groove, and said second capturing portion of each of said press rings includes a radially outwardly extending barb engaging said groove of each of a different one of said of first capturing portions.

5. A ball valve assembly according to claim 1, wherein each of said retainers includes a first sealing member and a second sealing member, each of said first sealing members are compressively positioned between said valve ball and a respective one of said retainers, and each of said second sealing members are compressively positioned between said respective one of said retainers and said valve body.

6. A ball valve assembly according to claim 1, wherein said valve ball has an exterior wall, and at least a portion of said exterior wall has a spherical surface.

7. A ball valve assembly according to claim 6, wherein each of said retainers includes a first sealing member and a second sealing member, each of said first sealing members are compressively positioned between said spherical surface of said exterior wall and a respective one of said retainers, and each of said second sealing members are compressively positioned between said respective one of said retainers and said valve body.

8. A ball valve assembly according to claim 7, wherein each of said retainers includes a first retainer ring and a second retainer ring, said first retainer ring has a spherical wall portion cooperative with said spherical surface of said valve body.

9. A ball valve assembly according to claim 7, wherein each of said retainers includes a first retainer ring and a second retainer ring, said first retainer ring has a first annular shoulder and said second retainer ring has a second annular shoulder, said first and said second retainer rings interengaging one another such that said first and second annular shoulders form an annular sealing cavity for receiving and retaining said first sealing member.

10. A ball valve assembly according to claim 1 further comprising an end fitting supported on one of said opposing ends of said valve body.

11. A ball valve assembly according to claim 10, wherein said end fitting is welded onto said valve body.

12. A polymeric ball valve assembly comprising:
a polymeric valve body having opposing end walls, an inside wall forming a central passage extending between opposing ends adjacent said end walls, and an annular groove disposed along said central passage adjacent each of said opposing ends thereof, each of said grooves extending radially outwardly into said valve body;
a polymeric valve ball having an exterior wall, an inside wall that forms a fluid passage extending through said valve ball, at least a portion of said exterior wall has a spherical surface extending therealong, and said valve ball is rotatably supported within said central passage of said valve body;
a valve stem extending through said valve body into said central passage thereof and interengaging said valve ball;
a first and a second polymeric seal retainer supported within said central passage on opposing sides of said valve ball, each of said first and said second seal retainers including an elastomeric ball sealing member and an elastomeric body sealing member, said ball sealing members compressively positioned between said spherical surface of said valve ball and a respective one of said seal retainers forming a fluid-tight seal therebetween, said body sealing members compressively positioned between said respective one of said sealing members and said inside wall of said valve body; and,
a first and a second polymeric press ring captured within said central passage each abuttingly engaging a different one of said first and said second seal retainers, each of said press rings having a generally radial exterior wall and an annular ridge extending radially outwardly from said exterior wall, said annular ridge of each of said first and said second press rings is received a different one of said grooves of said valve body to capture said press rings therein.

13. A polymeric ball valve assembly according to claim 12, wherein said valve stem is formed from a polymeric material.

14. A polymeric ball valve assembly according to claim 12, wherein said grooves of said valve body each include a frustoconical wall portion and a female shoulder portion positioned outboard of said frustoconical wall portion, and said annular ridge of each of said press rings includes a complimentary frustoconical wall portion and a complimentary male shoulder portion, said female shoulder portion of each of said grooves respectively capturing said male shoulder portion of each of said press rings preventing axially outward displacement of said first and said second seal retainers.

15. A polymeric ball valve assembly according to claim 12 further comprising a polymeric end fitting attached to said valve body.

16. A polymeric ball valve assembly according to claim 14, wherein said valve body and said end fitting are formed from thermoplastic, and said end fitting is attached to said valve body by thermoplastic welding.

17. A method of assembling a ball valve assembly comprising the steps of:
providing individual components of said ball valve assembly to be assembled including a valve body, a valve ball, a valve stem, a first and a second retainer, and a first and a second press ring, said valve body having a central inside wall forming a central passage and a secondary inside wall forming a stem passage extending through said valve body into and generally transverse said central passage;
providing a base fixture and positioning said first press ring on said base fixture;
supporting said first retainer generally coaxially on said first press ring;
assembling said valve ball into said central passage of said valve body with said valve stem extending through said stem passage of said valve body and interengaging said valve ball;
supporting said valve body with said valve ball and valve stem on said first retainer such that said central passage is generally coaxial with said first retainer;
supporting said second retainer on said valve body opposite said first retainer, said second retainer positioned generally coaxially with said central passage;
supporting said second press ring generally coaxially on said second retainer;
positioning a second fixture adjacent said second press ring, and axially displacing at least one of said base fixture and said second fixture toward one until said first and said second press rings are at least partially received in opposing ends of said central passage.

18. A method of assembling a ball valve assembly according to claim 16, wherein said inside wall of said valve body includes a capturing groove adjacent opposing ends thereof, and each of said first and said second press rings has an exterior wall with a generally annular ridge extending radially outwardly therefrom, said step of axially displacing said base fixture and said second fixture toward one another includes displacing said fixtures toward one another until said ridge of each of said press rings interengages said groove of an associated end of said inside wall.

19. A method of assembling a ball valve assembly according to claim 16 further comprising the steps of providing an end fitting, said end fitting and said valve body being formed from thermoplastic materials, and attaching said end fitting to one end of said valve body by thermoplastic welding.
